(19) United States
(12) Patent Application Publication
(10) Pub. No.: US 2006/0033699 A1
(43) Pub. Date: Feb. 16, 2006

(54) Back light module driver of a liquid crystal display for driving multiple lamps

(76) Inventors: Hung-Lieh Yu, Taichung (TW); Tsung-Pao Hung, Taichung (TW); Chia-Chun Lo, Taichung (TW)

Correspondence Address: BINGHAM, MCCUTCHEN LLP, THREE EMBARCADERO CENTER, 18 FLOOR, SAN FRANCISCO, CA, 94111-4067, US

(21) Appl. No.: 10/914,230

(22) Filed: Aug. 10, 2004

(51) Int. Cl. G09G 3/36

(52) U.S. Cl. 345/102

(57) ABSTRACT

A back light module driver of a liquid crystal display has an abnormal voltage detection unit and a loop protection unit. The abnormal voltage is connected between a boosting transformer and the loop protection unit. The loop protection unit is connected to a switching unit, that makes the boosting transformer outputs the high voltage driving power to multiple lamps. If the boosting transformer has voltage leakage or high abnormal voltage status the abnormal voltage detection unit will detect and then output a high output voltage to loop protection unit. The loop protection unit will immediately stop operation of the switching unit to stop driving the lamps.

### BACKGROUND OF THE INVENTION

1. Field of the Invention

The present invention relates to a back light module driver for a liquid crystal display (LCD) and more particularly to a back light module driver to drive multiple lamps and having loop protection and abnormal voltage detection capabilities.

2. Description of Related Art

Liquid crystal display (LCD) requires a back light module to display image. For different display sizes, the back light module has different quantities of lamps and of course, the back light module driver is not the same.

With reference to FIG. 4, an inverter of the driver for small quantities of lamps has a boosting transformer (T1), switching transistors (Q1, Q2) and an oscillator (OSC). The switching transistors (Q1, Q2) are connected between the oscillator (OSC) and a first primary coil of the boosting transformer (T1). The switching transistors (Q1, Q2) are controlled to respectively turn on or turn off by the oscillator (OSC), so a secondary coil of the boosting transformer has AC driving power source with very high voltage. Since the LCD is thin, a miniature boosting transformer is required. Two ends of the secondary coil of the boosting transformer (T1) are respectively connected to a very high voltage and a zero voltage to have a very high voltage of the driving power source for lamps (L), so some drawbacks of the boosting transformer are occurred.

1. Dielectric treatment is more and more difficult.

2. Low numbers of lamps are driven by the inverter. With reference to FIG. 6, if the inverter would like to drive more numbers of the lamps, the inverter will require more transformers (T1).

3. Intensity of the lamp is not uniform. With reference to FIGS. 9B and 10, two intensity curves (C11, C12) of the two lamps (L1, L2) in the back light module (90) are shown. The two lamps (L1, L2) are driven at the same time by the inverter. There is a larger drop height between the two intensities of the two ends (A1, A11, B1, B11) of each lamp (11, 12). The intensities of the two lamps (L1, L2) are different. Therefore, the back light module (90) will provide a not uniform intensity to effect the display quality of the LCD.

With reference to FIG. 5, since the lamp (L) has a metal lid (70) to reflect light upward, multiple stray capacitors (71) are occurred between the lamp (L) and the metal lid (70). When an input current (I1) passes through the lamp (L), multiple stray capacitors (71) share the portion of the input current in the lamp (L) so an output current (I2) is smaller than the input current. Therefore, the intensity curve of the lamp is not uniform.

With reference to FIG. 7, an inverter is provided to solve the above drawbacks. The inverter has a boosting transformer (T2), switched transistors (Q3, Q4) and an oscillator (81). A secondary coil of the boosting transformer (T2) has three ends (V1, V2, V3), wherein the two ends (V1, V3) are connected to high voltage and the central end (V2) is connected to ground. Therefore, referring to FIG. 8, even though the stray capacitors (82) are occurred between the lamp (L) and the metal lid (83), the input current and output current will be nearly the same and the central current is smaller than the input and output current. Therefore, the inverter can provide more uniform intensify.

Although the inverter solves the drawbacks of the first conventional inverter, the inverter still has other drawbacks. Since the inverter is used to drive the back light module of the LCD, the safety for driving the lamps should be provided to ensure the quality of the back light module. In addition, the boosting transformer (T2) further has a feedback coil (81) to use as the oscillator except the primary and secondary coils. Therefore, the primary coil is easy to effect by the feedback coil to output unstable driving power to lamp (L).

Therefore, the present invention provides a driver for back light module having lamp protection and abnormal voltage detection capabilities.

### SUMMARY OF THE INVENTION

The main objective of the present invention is to provide a driver of a back light module that has a lamp protection capability.

Another objective of the present invention is to provide a driver of the back light module that further has an abnormal voltage detection capability.

When the driver detects power loop of any lamp are opened or the abnormal voltage is occurred, the driver will immediately interrupt the driving power to the other lamps. Therefore, the driver in accordance with the present invention provides a very safety protection capability of the back light module.

Other objectives, advantages and novel features of the invention will become more apparent from the following detailed description when taken in conjunction with the accompanying drawings.

### BRIEF DESCRIPTION OF THE DRAWINGS

FIG. 1 is a functional diagram of a first embodiment of a driver of a back light module in accordance with the present invention;

FIG. 2 is a functional diagram of a second embodiment of a driver of a back light module in accordance with the present invention;

FIGS. 3A to 3G are circuit diagrams of the second embodiment of the driver in accordance with the present invention;

FIG. 4 is a circuit diagram of a conventional inverter of a driver in accordance with the prior art;

FIG. 5 is a schematic view of a structure of one lamp of a metal lid in the back light module;

FIG. 6 is the circuit diagram of FIG. 4 without the switching transistors and oscillator but using two transformer;

FIG. 7 is a circuit diagram of a conventional inverter of a driver in accordance with the prior art;

FIG. 8 is a portion of the circuit diagram of FIG. 7;

FIG. 9A is an intensity measurement diagram of two lamps driven by the driver in accordance with the present;

FIG. 9B is an intensity measurement diagram of two lamps driven by the inverter shown in FIG. 4; and

FIG. 10 is schematic view of the two lamps in the back light module.

### DETAILED DESCRIPTION OF THE PREFERRED EMBODIMENT

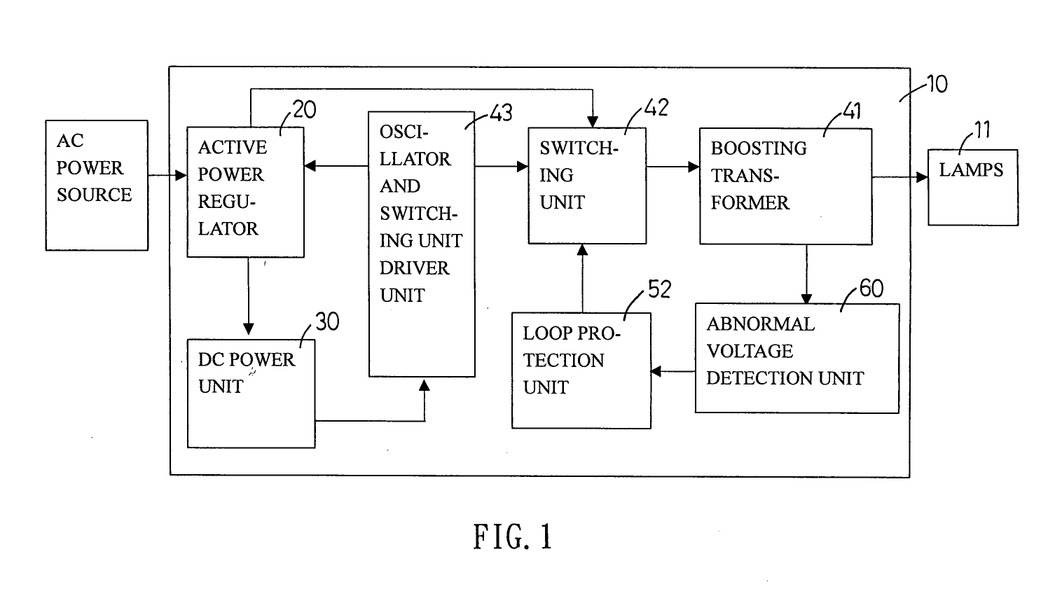

With reference to FIG. 1, a back light module driver (10) of a first embodiment in accordance with the present invention has an active power regulator (20), a DC power unit (30) with low voltage, an oscillator and switching unit driver unit (43), a switching unit (42), a boosting transformer (41), an abnormal voltage detection unit (60) and a loop protection unit (52).

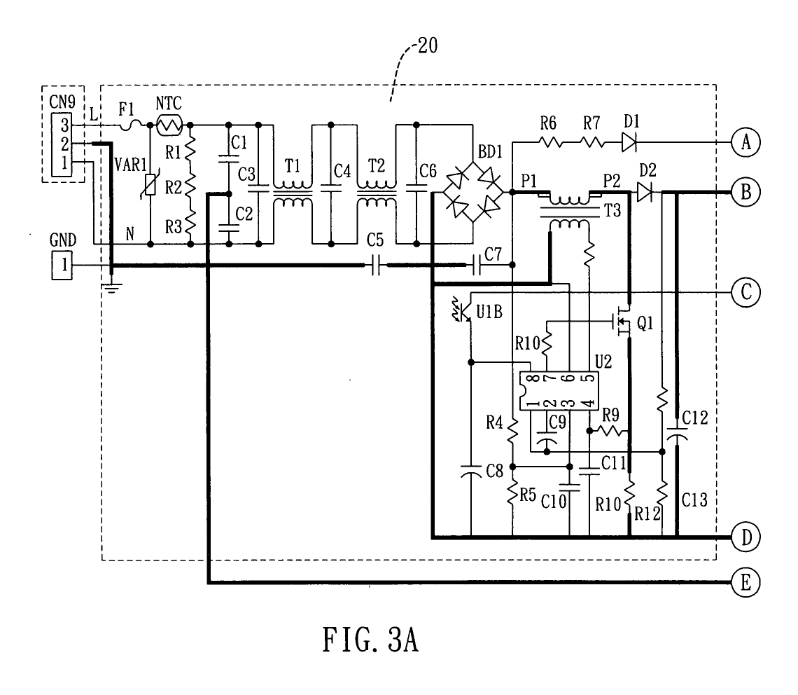

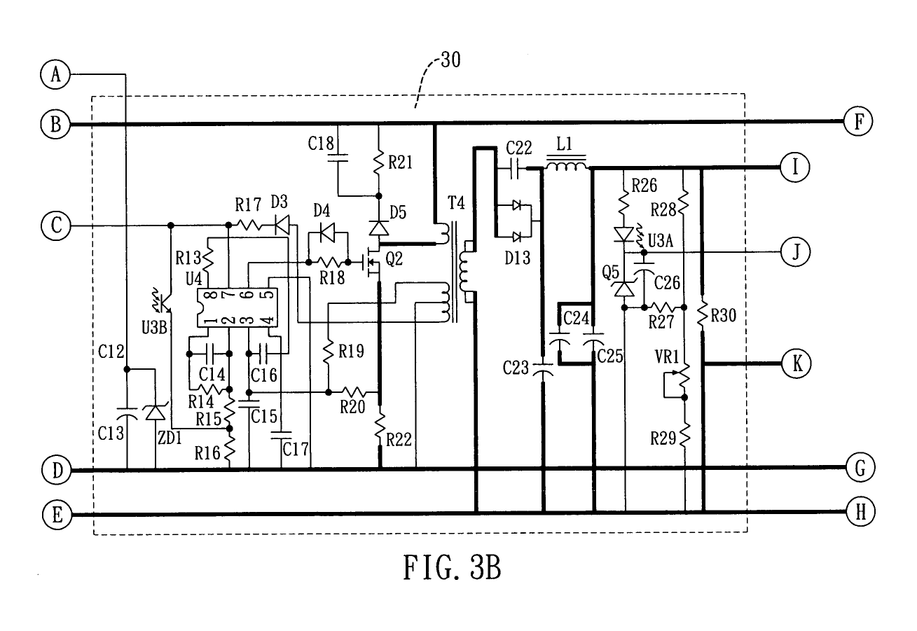

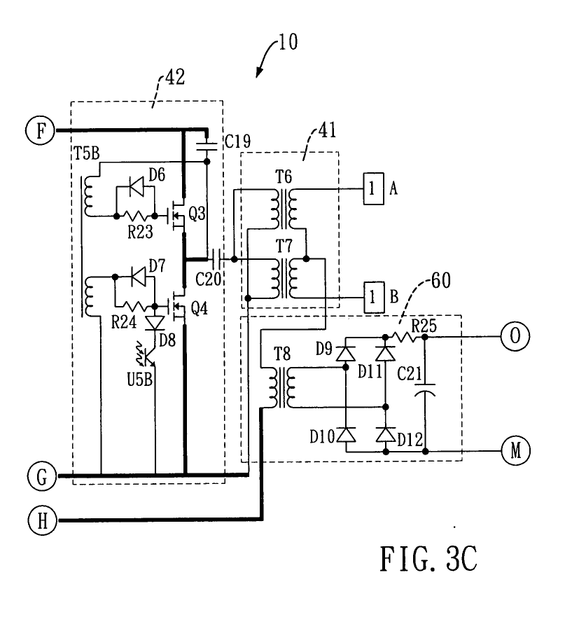

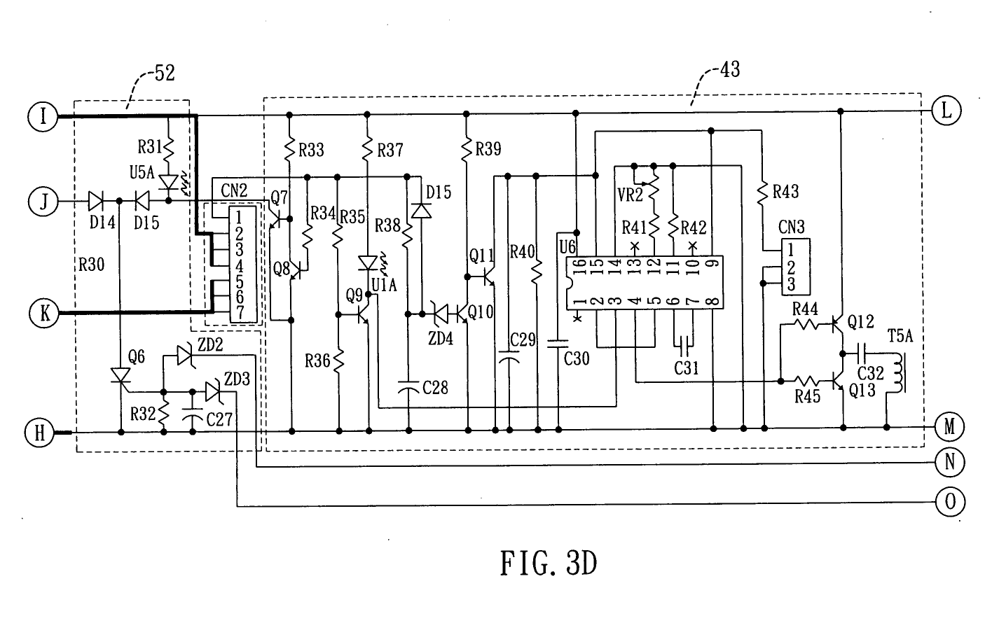

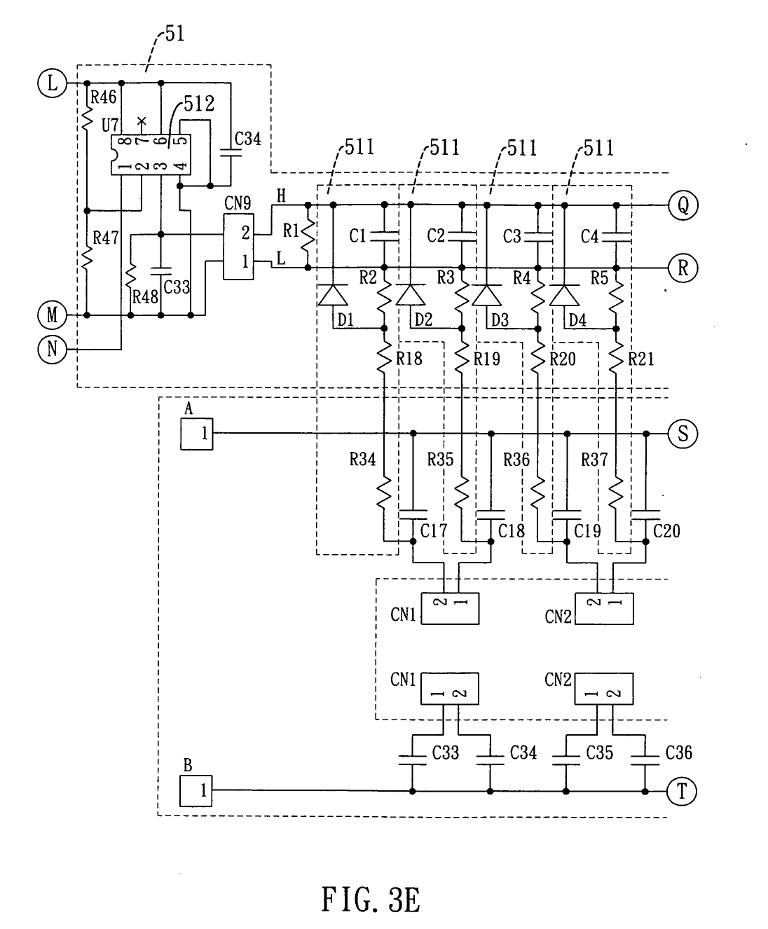

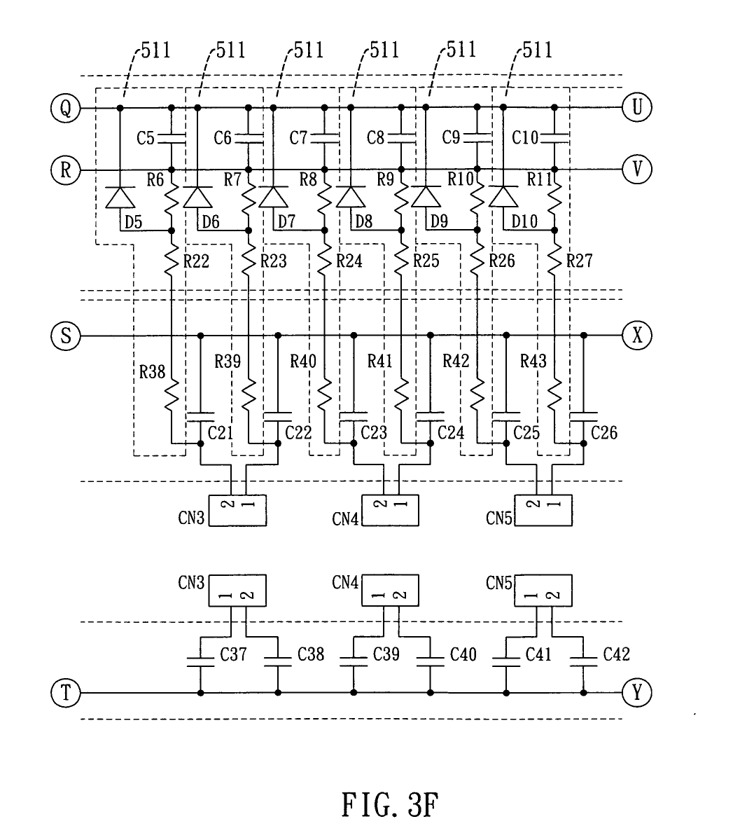

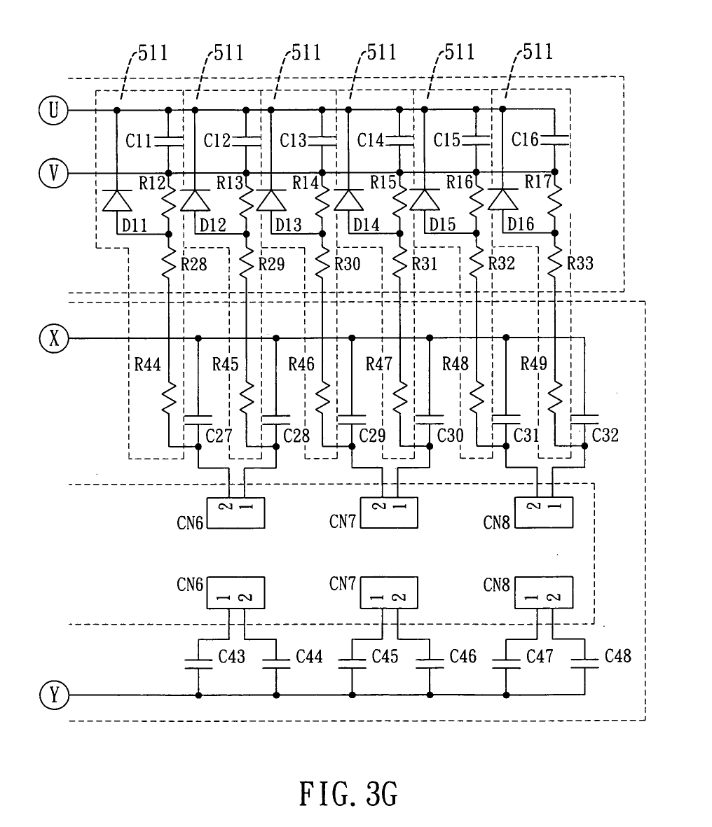

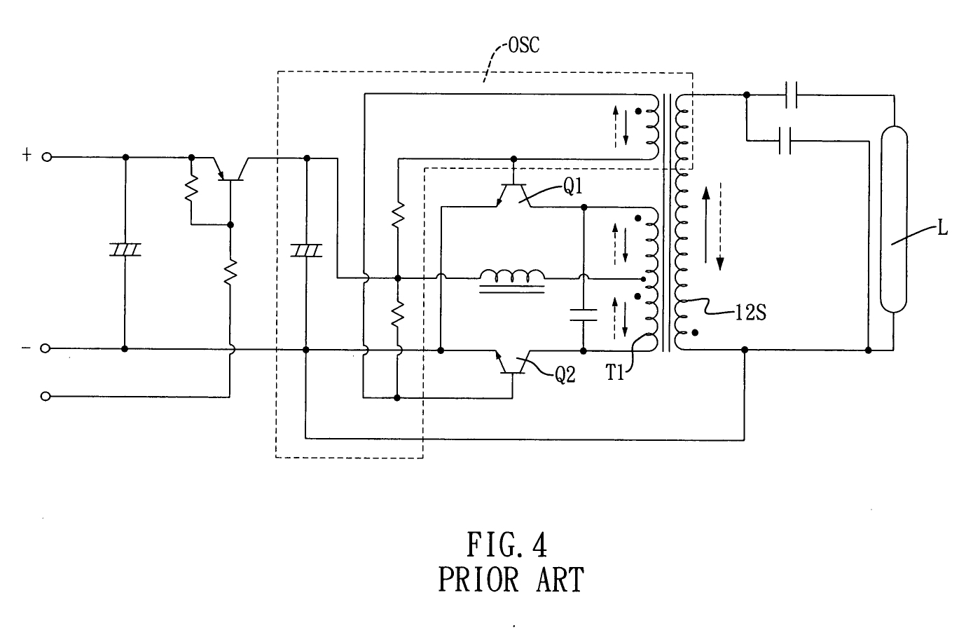

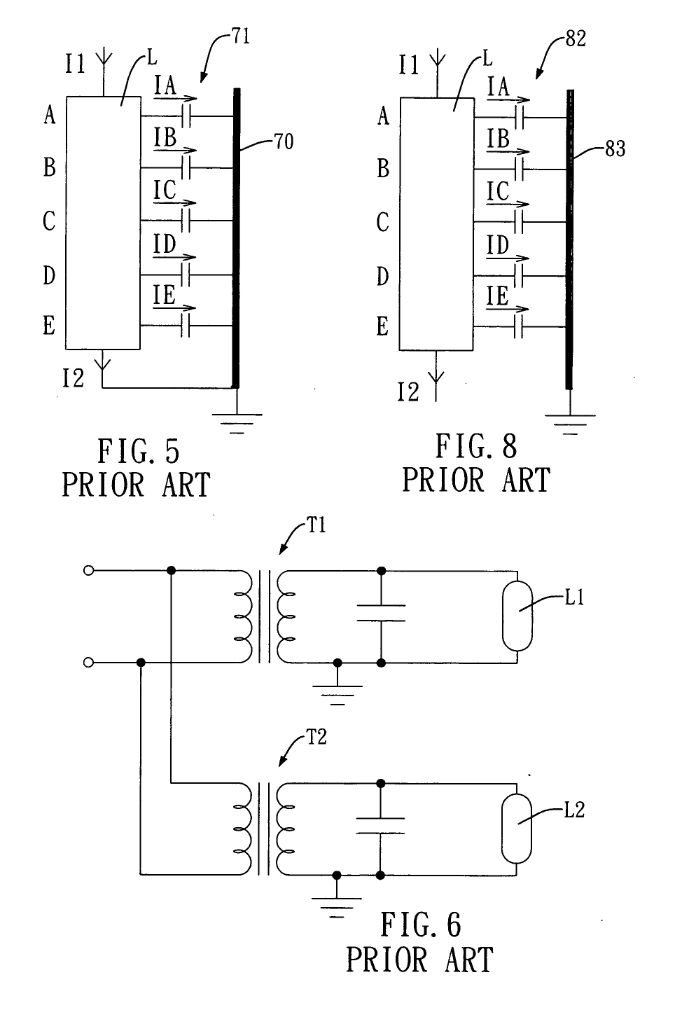

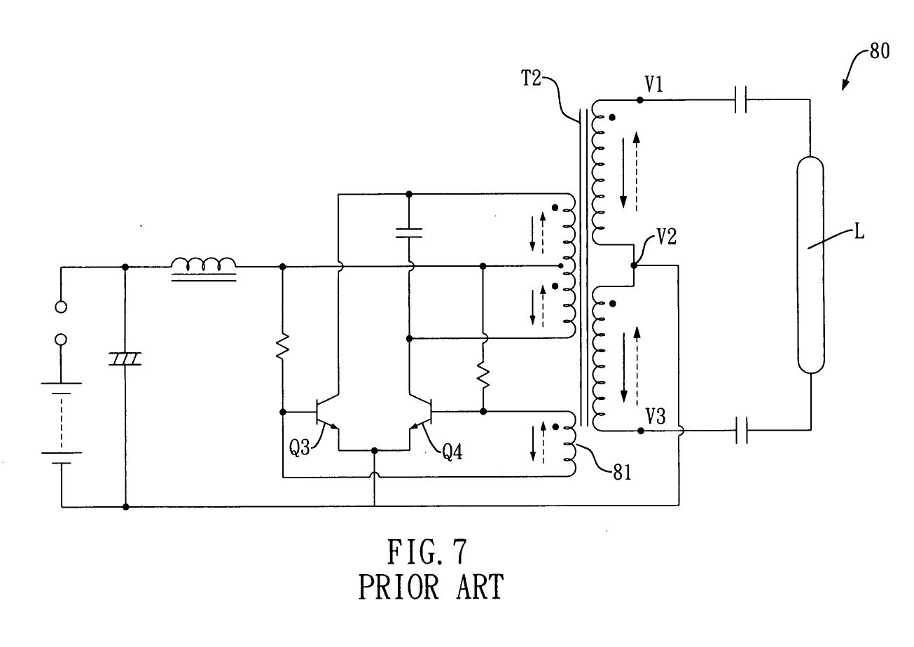

With further reference to FIGS. 3A to 3D, the active power regulator (20) is connected to an AC power source to convert an AC power to DC power and then outputs to the DC power unit (30). The DC power unit (30) is connected between the active power regulator (20) and the oscillator and switching unit driver unit (43). The DC power unit (30) is converted the DC power to DC power with low voltage. The low voltage DC power will be provided to the oscillator and switching unit driver unit (43).

The switching unit (42) is connected between the oscillator and switching unit driver unit (43) and the boosting transformer (41). The oscillator and switching unit driver unit (43) controls a duty cycle of the switching unit (42). The switching unit (42) is able to be a full-bridge switching circuit or a half-bridge switching circuit.

The boosting transformer (41) has a primary coil and a secondary coil. The secondary coil is has a first end, a second end and a central end. The first and second ends provide very high voltage and are connected to two ends of each lamp (11). Therefore, the two ends of each lamp obtain the very high voltage.

The abnormal voltage detection unit (60) is connected between the central end of the secondary coil of the boosting transformer (41) to detect that there is any abnormal voltage occurred on the secondary coil.

The loop protection unit (52) is connected between the abnormal voltage detection unit (60) and the switching unit (42). The loop protection unit (52) determines whether the voltage output from the abnormal voltage detection unit (60) is abnormal or not. If so, the loop protection unit (52) will immediately stop the operation of the switching unit (42) and the boosting does not output high voltage driving power to lamps (11).

With further reference to FIGS. 3C and 3D, the abnormal voltage detection unit (60) mainly has a transformer (T8) and a rectifier (D9˜D12). The transformer (T8) also has a primary coil connected to the secondary coil of the boosting transformer (41), and a secondary coil connected to the rectifier (D9˜D12). Therefore, when secondary coil of the boosting transformer (41) has a leakage voltage or a high voltage status, the transformer (T8) outputs a high voltage.

The loop protection unit (52) mainly has a first zener diode (ZD3), an optional second zener diode (ZD2), a silicon controlled rectifier (SCR) (Q6), an optical coupled element (not numbered) consisted of a light emitting diode (U5A) and a light transistor (U5B). The light transistor (U5B) is connected to the switching unit (42) in serial. The first and second zener diodes (ZD3, ZD2) are connected between the abnormal voltage detection unit (60) and a trigger terminal of the SCR (Q6). The light diode (U5A) is connected to the SCR (Q6) in serial. When the abnormal voltage detection unit (60) outputs the high voltage to the first zener diode (ZD3), the first zener diode (ZD3) will turn on to trigger terminal the SCR (Q6). When the SCR (Q6) is triggered to turn on, the light diode (U5A) outputs lights to the optical transistor (U5B). The optical transistor (U5B) will turn on to stop the switching unit's operation. Since the switching unit (42) does not operate, the secondary coil does not provide does not high voltage to the lamps (11).

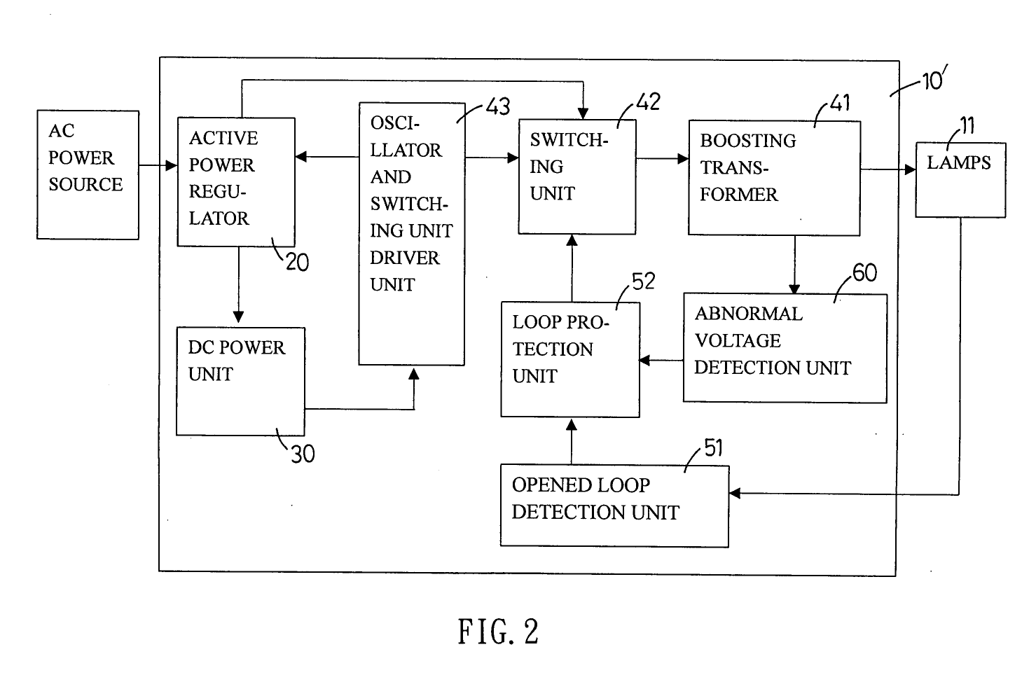

With reference to FIGS. 2 and 3C to 3G, a second embodiment of the driver (10′) in accordance with the present invention further has a opened loop detection unit (51) connected to one end of each lamp (11) and the second zener diode (ZD2) of the loop protection unit (52). When the opened loop detection unit (51) detects that any loop of the lamp is opened, the opened loop detection unit (51) will output a detection signal with high voltage to the loop protection unit (52) to stop the switching unit's operation.

The opened loop detection unit (51) mainly includes multiple voltage detectors (511) and a controller (512). Each lamp (not shown) of the present invention is connected to the first and second ends (A, B) through the corresponding voltage detector (511). Each voltage detector (511) is connected to the controller (512).

Each voltage detector (511) is able to be a voltage divider. If each lamp's operation is normal, the controller (512) detects a low voltage through the voltage divider (511). If any one lamp (not shown) is broken to make the loop of the lamp open, the controller (512) will detect a high voltage through the voltage divider (511) and then the controller (512) will immediately output a loop opened signal to the loop protection unit (52). The loop protection unit (52) stops the operation of the switching unit (42). That is, when the controller (512) outputs a high voltage to the second zener diode (ZD2), the second zener diode (ZD2) will turn on to trigger the SCR (Q6). When the SCR (Q6) is triggered to turn on, the light diode (U5A) outputs light to the optical transistor (U5B). The optical transistor (U5B) will turn on to stop the switching unit's operation. Since the switching unit (42) does not operate, the secondary coil does not provide does not high voltage to the lamps.

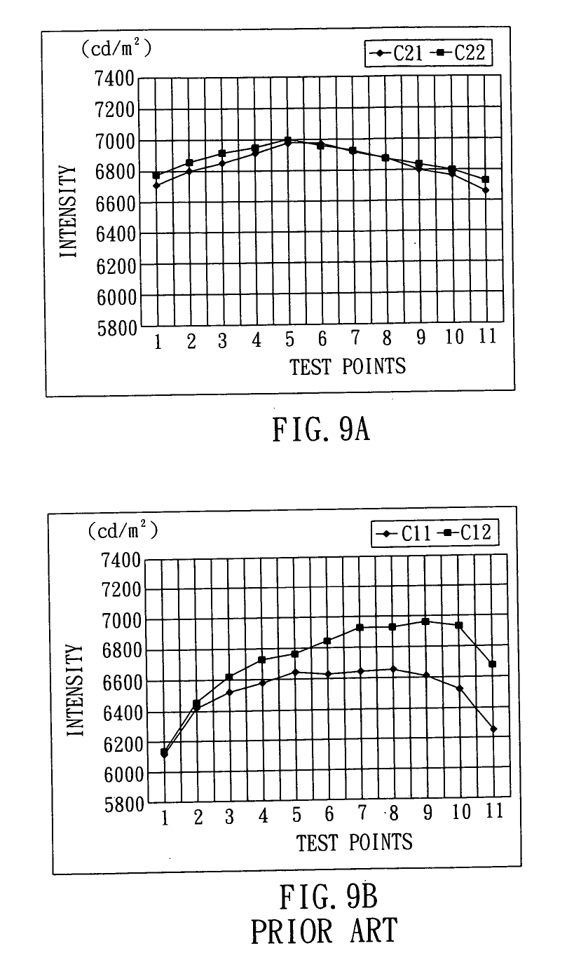

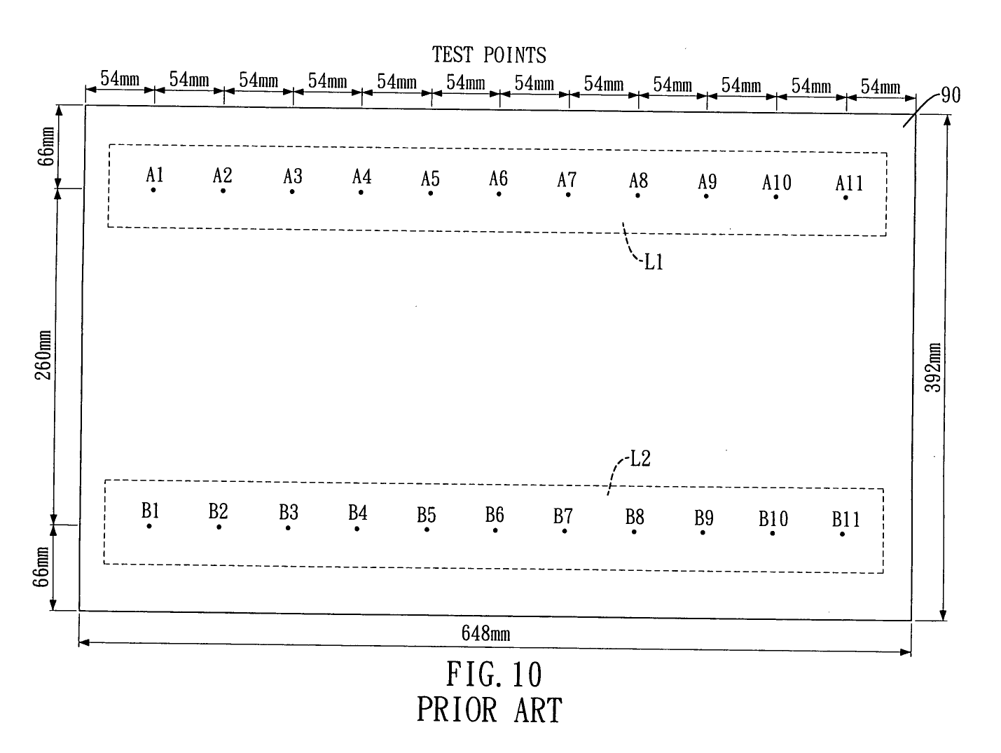

With reference to FIG. 3C, the boosting transformer (41) does not include a feedback coil to use as an oscillator, and is controlled by an external oscillator. Therefore, the oscillator does not effect the boosting transformer (41) and the present invention provides a stable driving voltage to the lamps. With reference to FIGS. 9A, the two intensify curves (C21, C22) of the two lamps (11, 12) driven by the present invention are slightly the same. A drop height between the two intensifies of the two ends of each lamp is smaller so the back light module with the present invention provides the uniform brightness. Further, since the boosting transformer (41) only has primary coil and secondary coil, the boosting transformer (41) is easily fabricated to be adapt to different numbers of lamps.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A back light module driver of a liquid crystal display comprising;
an active power regulator adapted to connect to an external AC power source to convert AC power to DC power;
a DC power unit with a low voltage connected to active power regulator to convert the DC power to an DC power with the low voltage;
an oscillator and switching unit driver unit connected to the DC power unit to obtain DC power with the low voltage;
a switching unit connected to the oscillator and switching unit driver unit, wherein the oscillator and switching unit driver unit controls a duty cycle of the switching unit;
a boosting transformer having a primary coil connected to the switching unit, and a second coil adapted to connect to multiple lamps;
an abnormal voltage detection unit connected to the secondary coil to detect that an abnormal voltage is occurred on the secondary coil and to output high voltage if the abnormal voltage is occurred; and
a loop protection unit connected between the switching unit and the abnormal voltage detection unit, wherein the loop protection unit stops an operation of the switching when the abnormal voltage detection unit outputs the high voltage.

2. The back light module driver as claimed in claim 1, wherein the abnormal voltage detection unit comprises a transformer and a rectifier, wherein the transformer has a primary coil connected to the secondary coil of the boosting transformer, and a secondary coil connected to the rectifier.

3. The back light module driver as claimed in claim 2, wherein the loop protection unit comprises:
a first zener diode connected to the rectifier;
a silicon controlled rectifier (SCR) having a trigger terminal connected to the first zener; and
an optical coupled element having a light emitting diode and a light transistor, wherein the light transistor is connected to the switching unit in serial and the light diode is connected to the SCR;
whereby when the rectifier outputs the high voltage, the first zener diode, SCR and light diode are turned on and then the light transistor will turn on to stop the operation of the switching unit.

4. The back light module driver as claimed in claim 1, further comprising a opened loop detection unit adapted to connect to two ends of each lamp and the loop protection unit, wherein the opened loop detection unit is used to detect any opened loop of the lamp and then outputs a high voltage to the loop protection unit.

5. The back light module driver as claimed in claim 2, further comprising a opened loop detection unit adapted to connect to two ends of each lamp and the loop protection unit, wherein the opened loop detection unit is used to detect any opened loop of the lamp and then outputs a high voltage to the loop protection unit.

6. The back light module driver as claimed in claim 3, further comprising:
an opened loop detection unit adapted to connect to two ends of each lamp and the loop protection unit, wherein the opened loop detection unit is used to detect any opened loop of the lamp and then outputs a high voltage to the loop protection unit; and
the loop protection unit further comprises a second zener diode connected between the opened loop detection unit and the trigger terminal of the SCR.

7. The back light module driver as claimed in claim 4, wherein the opened loop detection unit having multiple voltage dividers that are respectively adapted to correspond to the multiple lamps and a controller connected to the loop protection unit.

8. The back light module driver as claimed in claim 5, wherein the opened loop detection unit having multiple voltage dividers that are respectively adapted to correspond to the multiple lamps and a controller connected to the loop protection unit.

9. The back light module driver as claimed in claim 6, wherein the opened loop detection unit having multiple voltage dividers that are respectively adapted to correspond to the multiple lamps and a controller connected to the second zener diode of the loop protection unit.

10. The back light module driver as claimed in claim 1, wherein the switching unit is a full-bridge circuit.

11. The back light module driver as claimed in claim 1, wherein the switching unit is a half-bridge circuit.
